(19) United States
(12) Patent Application Publication
(10) Pub. No.: US 2017/0328475 A1
(43) Pub. Date: Nov. 16, 2017

(54) KNITTED HIGH TEMPERATURE SEAL

(71) Applicant: Jim Ray Campany, Houston, TX (US)

(72) Inventors: Paul L. Couvillion, Katy, TX (US); Louis Loya, Houston, TX (US)

(73) Assignee: Jim Ray Company, Houston, TX (US)

(21) Appl. No.: 15/152,691

(22) Filed: May 12, 2016

(51) Int. Cl. F16J 15/34

(52) U.S. Cl. CPC F16J 15/3496

(57) ABSTRACT

A high temperature seal is disclosed which is made of knitted expanded graphite. The expanded graphite is knitted into a tube and then the tube is rolled back onto itself to prepare a torus. The torus is then die formed into a U shape. Various materials may be added to the knitted tube to enhance desirable qualities. A spring may be added to the torus to give compression force to the seal surface.

### BACKGROUND OF THE INVENTION

### 1. Field of the Invention

The present invention relates to a novel combination of materials which addresses the long standing problem of persuading extreme high temperature volume compressible materials to maintain enough integrity to function as sealing elements without the need to apply external compression. More particularly the present invention utilizes a single or several strands of composite material suitable for knitting into a preform which is then die formed into the finished article. In the most simple form, the preform is a tube, although other geometries are possible.

### 2. Related Art

For valve stem and slow speed pump packing, elastomer and plastic materials have been employed. Sometimes the packing is machined to allow a spring or series of springs to press the seal into sealing contact with the shaft and bore. These materials serve well in a myriad of application but they fail to maintain their integrity in extreme high temperature applications due to thermal break down. Above around 650° F. almost no elastomer and few plastic remain stable for long.

Many variations on braided and knitted packing have been made over time, but most high temperature materials are still braided and cut to size and compressed to seal valve stems and pump shafts. A vast array of materials are used. Sometimes the seals are engaged (and kept engaged) by external bolts with springs to compensate for wear.

Knitted (or over-braided) material in seals has been used primarily as a reinforcement, used as an over-braid to strengthen softer sealing material within, or as a braid over braid to increase the seal cross section. Knitted metal backup rings die formed to shape have been used for many years. See for example U.S. Pat. No. 4,730,835. These seals do not take advantage of the ability of the knitted (or hollow braid) rolled geometries to shelter the fiber ends from wear and sealing contact variations. This material still has exposed ends and has the weaknesses explained previously, since the ends of multiple turns of packing can separate in use. Also the material serves as a backup, not the seal as in the present invention.

Also knitted material has been used for many years as a strengthening agent for a rubber or plastic sealing material such as described in U.S. Pat. Nos. 3,361,432 and 6,863,278—again the material which is knitted serves to strengthen, not to seal.

Expanded Graphite is a volume compressible material with limited recovery and low elongation, but it is subject to attack only by oxidizers in the temperature range of −400 to over 4000 Degrees F. The method of production of Expanded Graphite is well documented. See for example U.S. Pat. Nos. 1,137,373 and 3,040,061 for the methods employed to create the base material. One of the most common materials goes by the trademarked name GRAFOIL®, manufactured by GrafTech Industries.

The material is usually formed into thin sheets and either rolled and die formed or cut into ribbons and combined with a fiber carrier to be braided into rope packing. The braided rope must be kept under compression to seal, usually about twice the media pressure plus a “y” factor of about 1000 P.S.I. is required to engage and keep the seal working. To get around the need for constant compression, a seal geometry resembling a “U” or “V” in cross section has been tried. Attempts to use the braided material (or single strands) in a “U” shape have failed due to the necessity of using material which 1) has very low elasticity and 2) has ends which must be accounted for in the seal design. After testing, the seals usually show separation at the ends or between the strands, in each case allowing media leakage.

Die forming sheets of rolled expanded graphite to produce seals has been more successful both as a homogeneous material and with knitted wire mesh as a reinforcement, as long as the movement of the seal inner diameter (ID). and outer diameter (OD is kept very small. This design fails if it requires an elongation beyond about 2-3% due to the inherent lack of elongation in the expanded graphite. Attempts to internally spring load this material have not been successful in use as the pressure cycles the exposed edge of the joined material creates a leak path.

### SUMMARY OF THE INVENTION

It was decided to address these problems by a change in topology—instead of multiple strands of material cut to length and then die formed, one strand of material is knitted using the most basic Stockinette stitch which provides the most uniform distribution of material. The geometry of the stockinette stitch permits the material to expand or contract by a relatively slight bending of the individual strands instead of stretching or compressing strands lengthwise which allow the very low elasticity of the expanded graphite to conform to the sealing area/surface.

Although originally conceived to utilize expanded graphite/carbon fiber strands, the concept will also apply to any material capable of being knitted and compliant enough to serve as a sealing member. Other material combinations such as, but not limited to: expanded graphite/polybenzimidazole fiber, vermiculite/ceramic fiber, expanded graphite/rolled graphine (or carbon nanotubes) and boron nitride/glass fiber are also contemplated.

The material in knitted into a tube using the stockinette stitch and the tube rolled upon itself to form a torus. The torus is then die formed to make a U shape so that the two ends of the tube are encapsulated away from the sealing surface.

### BRIEF DESCRIPTION OF THE DRAWING

FIG. 1 is a depiction of a the expanded graphite knitted using a basic stockinette stitch.

FIG. 2 is a depiction of the expanded graphite knitted into a tube using the basic stockinette of FIG. 1.

FIG. 3 shows the tube being rolled into a torus shape.

FIG. 4 shows a partial cut away view of the completed torus.

FIG. 5 shows the completed torus of FIG. 4 after being die formed into a U shape.

FIG. 6 shows the completed and die formed seal of FIG. 5 with an added spring to provide more elasticity to the seal.

### DETAILED DESCRIPTION OF THE PREFERRED EMBODIMENT

As noted above expanded Graphite is a volume compressible material with limited recovery and low elongation, but it is subject to attack only by oxidizers in the temperature range of −400 to over 4000 Degrees F. The method of production of Expanded Graphite is well documented. See for example U.S. Pat. Nos. 1,137,373 and 3,040,061 for the methods employed to create the base material. One of the most common materials goes by the trademarked name Grafoil®, manufactured by GrafTech Industries

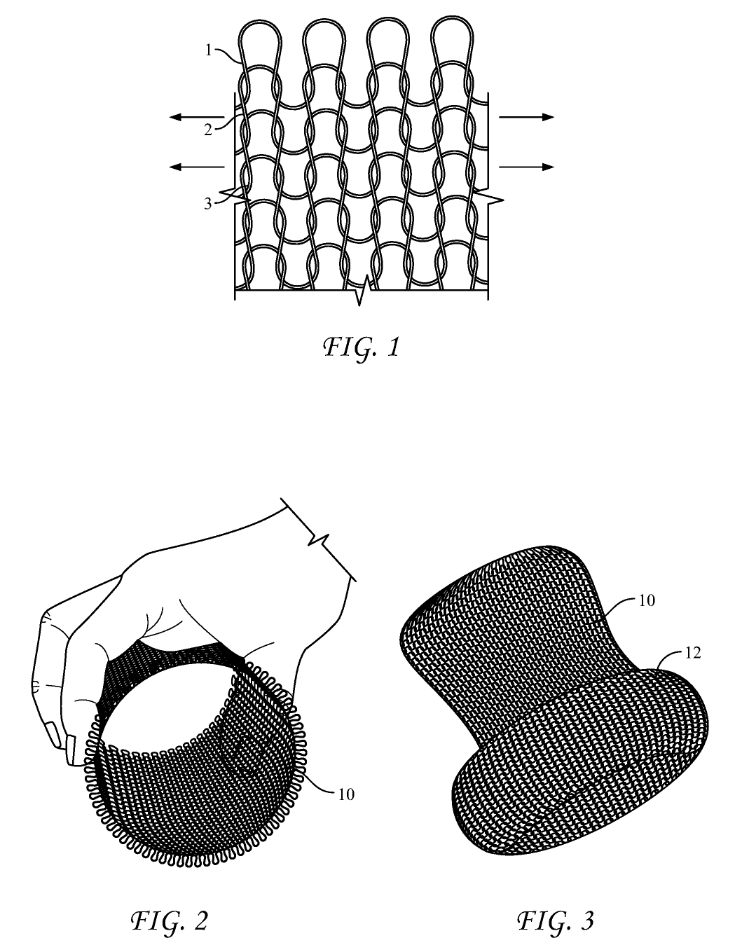

The strand or strands of the expanded graphite is knitted into a tube 10 of FIG. 2 using a stockinette stitch illustrated in FIG. 1. The strands 1, 2 and 3 are simply interlaced to allow moderate lateral expansion in the direction of the arrows with very little in the vertical direction. This lateral expansion is permitted by a slight bending of the individual strands as opposed to stretching orcopressing lengthwise.

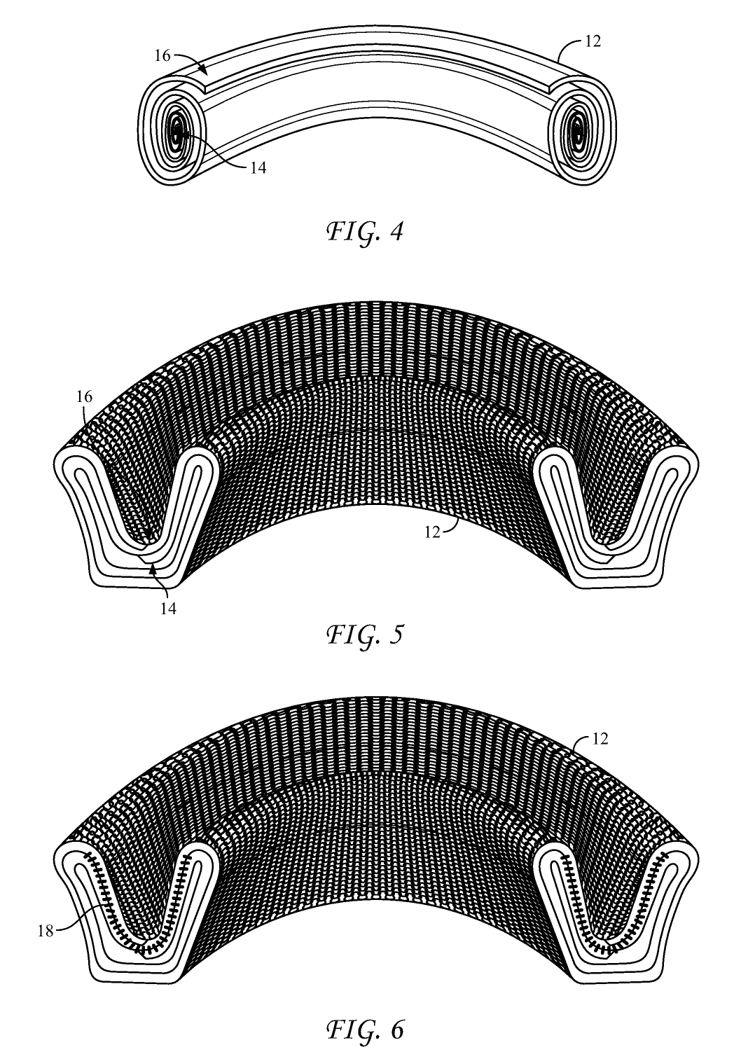

The knitted tube 10 is then rolled back onto it to form a torus, the beginning of which is shown in FIG. 3 at 12. It will be appreciated that the roll/torus 12 is continued until the tube 10 is completely absorbed into the torus shape. Torus 12 begins with one end 14 of the tube 10 in the middle of the cross section with outer edge 16 exposed as shown in FIG. 4.

The torus 12 is then die formed into a U shape as shown in FIG. 5. The two ends 14 and 16 are thus encapsulated and kept away from any sealing surface. In addition the U shape produces a slight outward biased to assist in maintaining the seal in contact with the sealing surfaces. In the present incarnation as shown in FIG. 6, the folded preform 12 is die formed with the addition of a “U” shaped spring 18 made out of a high temperature alloy, Inconel X750 for use up to 1100 Deg. F. The spring can be captured within a fold of material encapsulating it if desired. The spring 18 does not have to be U shaped. A spiral O shape will also serve to give a compression force to the inner and outer seal surfaces.

Although lacking the simplicity of the knitted single strand, the same advantages occur when using a braided tube of suitable diameter. It may be rolled to shield all of the ends from wear or exposure to the media.

The addition of a reinforcing wire or other stronger material either as a parallel strand being knitted or as a separately braided coaxial sleeve is easily accomplished. Also, it is contemplated that strands of material to enhance other properties of the finished seal can be added, such as a strand of pure polytetrafluoroethylene (TEFLON®) or a porous material to slowly dispense a lubricant.

Usually, blocking agents are not needed with expanded graphite or boron nitride, but they may aid in sealing for some of the other combinations. In all cases a suitable lubricating oil may be added, if desired, to serve to reduce friction during installation and break in.

Note that, although the seal is presented as a shaft or piston seal, the concept will work in other geometries such as a face seal. Also, the seal is presented as having one plane of sealing, but there is nothing preventing the knitted material from having multiple branches in 3 dimensions should such a seal be needed. In addition the final shape of the seal may be circular or rectangular in cross section while enjoying the advantages of the concept, as long as the edge of the material is not exposed to a dynamic surface.

1. A high temperature seal for use on a valve stem, wellhead casing, pump or turbine shaft, comprising expanded graphite knitted into a tube shape using a stockinette stitch, said knitted tube being rolled onto itself to form a torus and said torus being die formed into a U shape.

2. The high temperature seal according to claim 1 wherein said expanded graphite is in the form of multiple strands.

3. The high temperature seal according to claim 1 further comprising stands of reinforcing material are knitted into said tube along with said expanded graphite.

4. The high temperature seal according to claim 1 wherein a strand of pure polytetrafluoroethylene or a porous material to slowly dispense a lubricant is knitted into the tube along with the expanded graphite.

5. The high temperature seal according to claim 1 further comprising a U shaped spring is added to the torus prior to die forming the torus into a U shape.

6. A high temperature seal for use on a valve stem or pump shaft comprising expanded graphite braided into a tube shape, said braided tube being rolled onto itself to form a torus and said torus being die formed into a U shape.

7. (canceled)

8. (canceled)

9. (canceled)
